(19) United States
(12) Patent Application Publication
(10) Pub. No.: US 2026/0264773 A1
(43) Pub. Date: Sep. 10, 2026

(54) INSULATED CORNER ASSEMBLIES FOR REFRIGERATION TRAILERS AND TRUCKS

(71) Applicant: HYUNDAI TRANSLEAD, San Diego, CA (US)

(72) Inventors: Martin Martinez-Contreras, San Diego, CA (US); Alvaro J. Frausto, San Diego, CA (US); Oscar E. Montiel Rosales, Chula Vista, CA (US); Frederic Peter Graham, Spring Valley, CA (US)

(21) Appl. No.: 19/556,853

(22) Filed: Mar. 4, 2026

Related U.S. Application Data
(60) Provisional application No. 63/768,843, filed on Mar. 7, 2025.

(51) Int. Cl. B62D 33/04; B32B 5/18; B32B 15/04; B32B 15/20

(52) U.S. Cl. CPC B62D 33/048; B32B 5/18; B32B 15/046; B32B 15/20; B32B 2255/26; B32B 2266/0278; B32B 2307/304; B32B 2605/00

(57) ABSTRACT

Devices, systems, and methods relating to insulated corner assemblies for trailers and trucks having reduced thermal bridging and improved thermal efficiencies are provided. The insulated corner assemblies can include a top rail configured to couple a roof assembly to a side assembly. The roof assembly can include a vacuum insulated panel (VIP) inward of an interior-most surface of the top rail, and the side assembly can include a VIP perpendicular to the roof VIP. At least a portion of the side VIP can be inward of the interior-most surface of the top rail. An insulating spacer can be between the top rail and the roof VIP.

### CROSS-REFERENCE TO RELATED APPLICATIONS

This application claims priority to U.S. Provisional Patent Application No. 63/768,843 filed on Mar. 7, 2025, and entitled “INSULATED CORNER ASSEMBLIES FOR REFRIGERATION TRAILERS”. The application referenced in this paragraph is hereby incorporated by reference herein in its entirety.

### BACKGROUND

### Field

The present technology relates to an insulated corner assembly for refrigeration trailers and trucks.

### Description of the Related Art

Refrigeration trailers include insulation positioned interior to the trailer walls. The insulation aids in minimizing heat transfer into or out of the trailer. By minimizing transfer of heat into and out of the refrigeration trailer, an interior volume of the trailer can be maintained at a selected temperature relative to the temperature of the environment exterior to the trailer. The corners of refrigeration trailers can be vulnerable to greater heat transfer into or out of the trailer. This vulnerability can reduce the efficiency of the refrigeration trailer. Therefore, a need exists for improved insulated corner assemblies for refrigeration trailers.

### SUMMARY

For purposes of summarizing the present disclosure and its advantages, certain objects and advantages are described herein. Not all such objects or advantages may be achieved in any particular embodiment of the present disclosure. Thus, for example, those skilled in the art will recognize that the present disclosure may be embodied or carried out in a manner that achieves or optimizes one advantage or group of advantages as taught herein without necessarily achieving other objects or advantages as may be taught or suggested herein.

In one aspect, an insulated corner assembly for a trailer or truck is provided. The assembly includes a top rail configured to couple a roof assembly to a side assembly, the roof assembly including a roof vacuum insulated panel (VIP) inward of an interior-most surface of the top rail. The side assembly includes a side VIP perpendicular to the roof VIP. At least a portion of the side VIP is inward of the interior-most surface of the top rail. The assembly also includes an insulating spacer between the top rail and the roof VIP.

In some embodiments, a top surface of a foam coating of the side VIP adjoins the top rail.

In some embodiments, a foam coating of the roof VIP adjoins the foam coating of the side VIP.

In some embodiments, the insulating spacer adjoins a side surface of the foam coating of the roof VIP, and the insulating spacer is above the top surface of the foam coating of the side VIP.

In some embodiments, the assembly includes a roof bow supporter between the top rail and the roof VIP, where the insulating spacer is above the roof bow supporter.

In some embodiments, the assembly includes a roof bow supporter between the top rail and the roof VIP, where the insulating spacer is below the roof bow supporter.

In some embodiments, any horizontal cross-section taken along a height of the top rail passes through at least one of the roof VIP and the side VIP.

In some embodiments, a lowermost surface of the roof VIP is below a topmost surface of the side VIP.

In some embodiments, a first section of an exterior side of the side VIP adjoins an inner side of the top rail, and a second section of the exterior side of the side VIP contacts a side sheet of the side assembly.

In some embodiments, the top rail includes a roof sheet section separated from a side VIP section of the top rail by a distance of about 1 inch.

In another aspect, an insulated corner assembly for a trailer or truck is provided. The assembly includes a roof assembly, a side assembly, and a top rail. The roof assembly includes a roof insulated portion including a roof vacuum insulated panel (VIP) encased in a foam coating. The side assembly includes a side insulated portion including a side VIP encased in a foam coating. A lowermost surface of the roof VIP is below a topmost surface of the side VIP. The top rail is configured to attach the roof assembly to the side assembly.

In some embodiments, any horizontal cross section taken through the top rail passes through at least one of the roof VIP and the side VIP.

In some embodiments, the top rail includes a spacer section having a height between 0.5 inches and 2 inches and a width between 0.5 inches and 2 inches.

In some embodiments, the roof insulated portion has a height between 2 inches and 4 inches, and the side insulated portion has a width between 2 inches and 4 inches.

In some embodiments, the assembly further includes a roof sheet attached to a roof sheet section of the top rail.

In some embodiments, the assembly further includes a first insulating spacer between the roof sheet and the topmost surface of the side VIP.

In some embodiments, the roof assembly further includes a roof bow supporter between the top rail and the roof VIP, where the first insulating spacer is below the roof bow supporter.

In some embodiments, the assembly further includes a second insulating spacer above the roof bow supporter.

In some embodiments, the roof VIP is inward of an interior-most surface of the top rail, and at least a portion of the side VIP is inward of the interior-most surface of the top rail.

In some embodiments, the top rail includes a C-shaped section that defines a volume having a height of about 1 inch.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The above-mentioned aspects, as well as other features, aspects, and advantages of the present technology will now be described in connection with various embodiments, with reference to the accompanying drawings. The illustrated embodiments, however, are merely examples and are not intended to be limiting. Like reference numbers and designations in the various drawings indicate like elements.

The patent or application filed contains at least one drawing executed in color. Copies of this patent or patent application publication with color drawings will be provided by the Office upon request and payment of the necessary fee.

FIG. 1 illustrates a thermal image of a refrigeration trailer that includes vacuum insulated panel (VIP) insulation and a conventional insulated corner assembly.

FIG. 2 illustrates a perspective view of an embodiment of a refrigeration trailer according to an embodiment of the present disclosure.

FIG. 3A illustrates a cross-sectional view of an embodiment of an upper corner assembly of a refrigeration trailer according to an embodiment of the present disclosure.

FIG. 3B illustrates a cross-sectional view of an embodiment of an upper corner assembly of a refrigeration trailer according to an embodiment of the present disclosure showing example relative positions of components in view of standard manufacturing tolerances.

FIG. 4 illustrates a cross-sectional view of an embodiment of a top rail according to an embodiment of the present disclosure.

FIG. 5A illustrates a perspective section view of an embodiment of a conventional upper corner assembly of a refrigeration trailer.

FIG. 5B illustrates a perspective section view of an embodiment of an upper corner assembly of a refrigeration trailer according to the embodiments illustrated in FIGS. 3A and 3B.

### DETAILED DESCRIPTION

The effectiveness of insulation in refrigeration trailers can be diminished by thermal bridging through an insulated structure of the refrigeration trailer. In the case of a refrigeration trailer, the insulated structure can be structures of the trailer that define a refrigerated interior volume of the trailer. Thermal bridging can occur where the insulative properties of a structure are diminished due to decreased effective wall thickness or insulative properties in an area of the insulated structure. For example, wood or metal structural components extending through some or all of the thickness of an insulated portion of the structure can cause thermal bridging. Heat transfer through an insulated structure can be expressed through Fourier's law where the rate of heat transfer is dependent on thermal conductivity of an insulative material, the surface area of the interior surfaces of the insulated volume, the temperature difference between the insulated volume and the uninsulated exterior, and the thickness of the insulation. Therefore, areas of the insulated material which include thinner insulation or have a higher thermal conductivity will be more vulnerable to increased heat transfer and will reduce the overall insulative properties of the insulated structure.

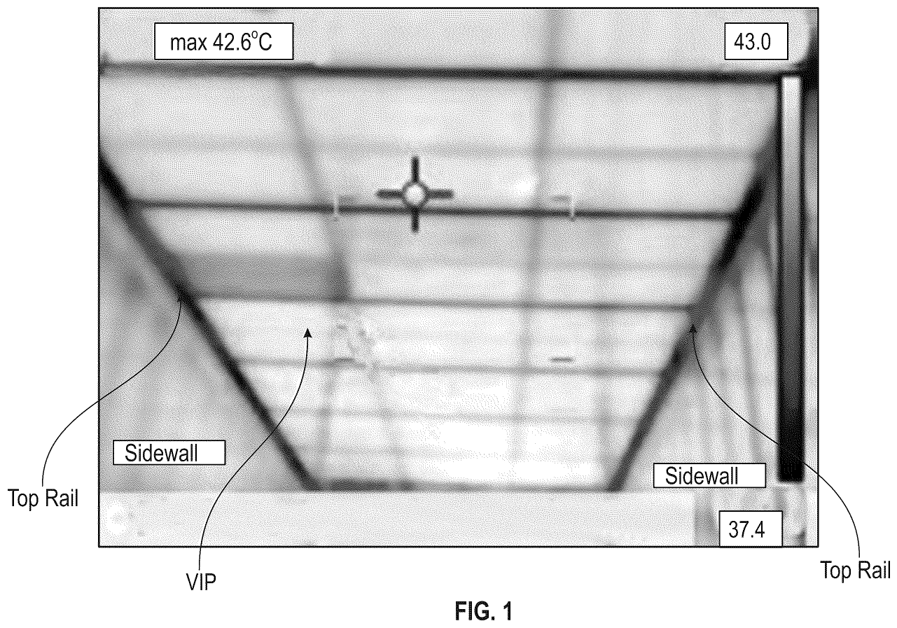

The corners in refrigeration trailers can be particularly vulnerable to thermal bridging because the interface between walls can introduce features with higher thermal conductivity into the insulated structure. Additionally, a trailer that uses vacuum insulated panels (VIPs) for insulation can be particularly vulnerable to thermal bridging relative to polyurethane (PU) foam insulation. Unlike PU foam insulation, which can be sprayed to fill voids and gaps in a variety of wall shapes and corners, each VIP panel is manufactured prior to installation. VIP panels often can have rectangular shapes and include edges and corners. Heat can more readily transfer from an exterior of the trailer to an interior of the trailer if the size, shape, location, and/or orientation of VIPs introduce thermal bridges. Additionally, VIPs can include a membrane wall which can form a thin, gas-tight outer envelope around a vacuum sealed porous core of the VIP. The membrane wall can have reduced insulative properties compared to the vacuum sealed porous core of the VIP. Therefore, heat can thermal bridge across the edges of the VIPs where one membrane wall adjoins or abuts another membrane wall. The membrane walls and/or connecting features between the membrane walls can cause the area between two VIPs to have reduced insulative properties. FIG. 1 illustrates a thermal image of a refrigeration trailer undergoing an industry standard thermal performance test. The refrigeration trailer includes vacuum insulated panel (VIP) insulation and a conventional insulated corner assembly. As shown in FIG. 1, refrigeration trailers that include VIP insulation can be particularly vulnerable to thermal bridging at the insulated corner assemblies. Therefore, there is a need for improved insulated corner assemblies in refrigeration trailers, particularly improved corner assemblies in refrigeration trailers using VIP panels.

The present disclosure describes upper corner assemblies in refrigeration trailers and trucks. Particularly, the disclosure describes side assemblies and roof assemblies that interface at corners having improved thermal properties. The insulated corner assemblies described herein can provide refrigeration trailers and trucks having improved thermal properties while maintaining or increasing the cargo space of the trailers and trucks. Although embodiments of the present disclosure are described with reference to upper corner assemblies in refrigeration trailers, it will be understood that upper corner assemblies according to the present disclosure can be suitably implemented on many different platforms, including but not limited to van trucks and truck bodies, storage containers, and refrigerated spaces in buildings, watercraft, and other types of vehicles.

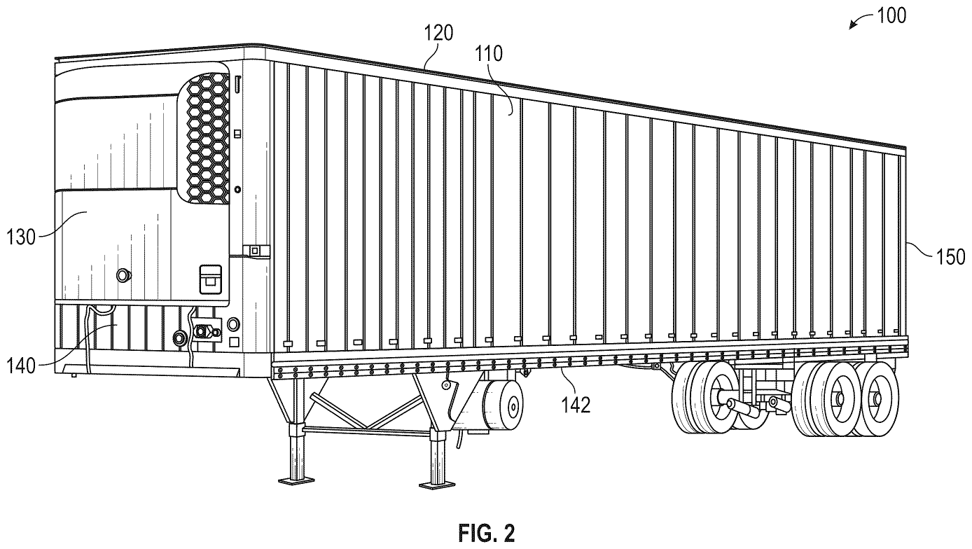

FIG. 2 illustrates a perspective view of a refrigeration trailer 100 according to an embodiment of the present disclosure. The refrigeration trailer 100 includes a front assembly 140 at the front of the trailer 100, a rear door assembly 150 at the rear of the trailer 100, a first side assembly 110, a second side assembly 110 (not visible in FIG. 2), a roof assembly 120, and a floor 142 assembly. A transportation refrigeration unit 130 can be attached to the front assembly 140. Each of the side assemblies 110, the roof assembly 120, the floor 142, the front assembly 140, and the rear door assembly 150 can be insulated. The refrigeration trailer 100 includes an insulated interior. The insulated interior can be a volume defined by the side assemblies 110, the roof assembly 120, the floor 142, the front assembly 140, and the rear door assembly 150.

The first side assembly 110 and the second side assembly 110 can each interface with the roof assembly 120. The first side assembly 110 and the second side assembly 110 can support the roof assembly 120. The interface between the first side assembly 110 and the roof assembly 120 can be watertight. The first side assembly 110 and the roof assembly 120 can couple to each other at an external corner, for example, outside the trailer 100. The first side assembly 110 and the roof assembly 120 can couple to each other at an interior corner, for example within the usable volume of the trailer 100. The corner where the first side assembly 110 to the roof assembly 120 interface can create a watertight joint between the first side assembly 110 and the roof assembly 120. The corner where the first side assembly 110 and the roof assembly 120 interface can hold the roof assembly 120 in tension, thereby maintaining the strength of the trailer 100.

The interface between the second side assembly 110 and the roof assembly 120 can be watertight. The second side assembly 110 and the roof assembly 120 can couple to each other at an external corner, for example outside the trailer 100. The second side assembly 110 and the roof assembly 120 can couple to each other at an interior corner, for example within the usable volume of the trailer 100. The corner where the second side assembly 110 to the roof assembly 120 interface can create a watertight joint between the second side assembly 110 and the roof assembly 120. The corner where the second side assembly 110 and the roof assembly 120 interface can hold the roof assembly 120 in tension, thereby maintaining the strength of the trailer 100.

The side assemblies 110 and the roof assembly 120 can include insulative materials. In some examples, the side assemblies 110 and the roof assembly 120 can be insulated with polyurethane (PU) foam. In some examples, the side assemblies 110 and the roof assembly 120 can be insulated with vacuum insulated panels (VIPs). In some examples, the side assemblies 110 and the roof assembly 120 can be insulated with a combination of VIPs and PU foam. Advantageously, VIPs can have a lower thermal conductivity than PU foam. The lower thermal conductivity of VIPs can advantageously allow for the use of side assemblies 110 and roof assemblies 120 having reduced wall thicknesses, while still achieving the same or better insulative properties as a trailer insulated with PU foam.

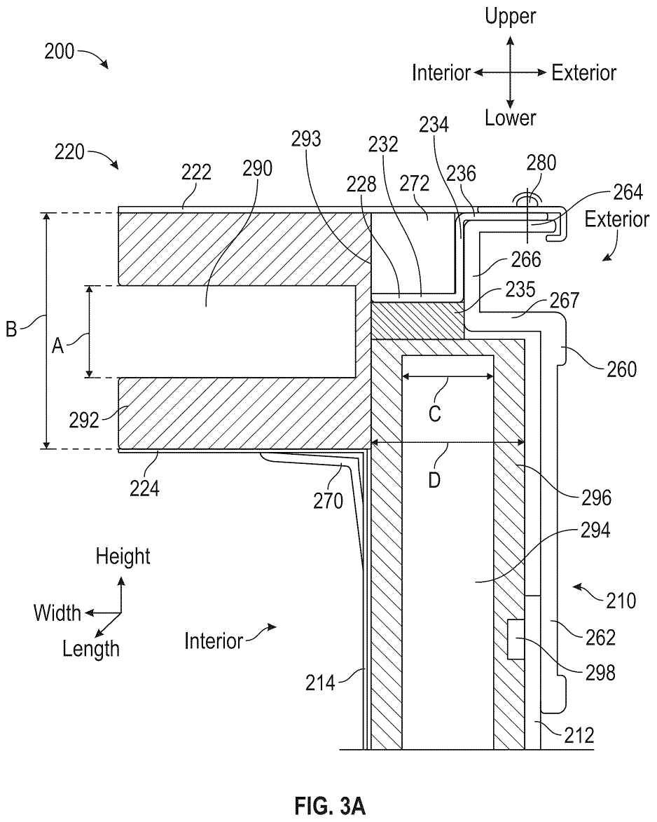

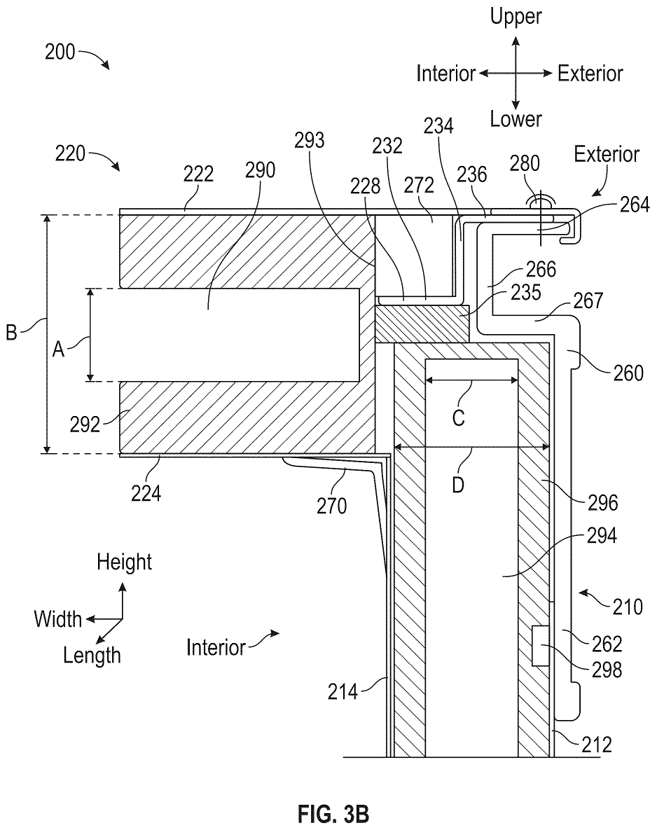

FIG. 3A illustrates a cross-sectional detailed view of an upper corner assembly of a refrigeration trailer 200 according to an embodiment of the present disclosure. FIG. 3B illustrates a cross-sectional detailed view of a corner assembly of a refrigeration trailer 200 showing example relative position of components in view of standard manufacturing tolerances. For example, FIG. 3B illustrates components of the upper corner assembly of FIG. 3A as those components may be positioned relative to each other in view of manufacturing tolerances. The upper corner includes an interface between a side assembly 210 and a roof assembly 220. Areas where the side assemblies 110 and the roof assembly 120 interface can be vulnerable to thermal bridges. The side assembly 210 can connect to the roof assembly 220. The top rail 260 can be configured to couple the roof assembly 220 to the side assembly 210. A top rail 260 can couple or connect the side assembly 210 to the roof assembly 220 at an exterior side of the upper corner. An inner corner bracket 270 can attach to the side assembly 210 and to the roof assembly 220 at an interior corner. While FIGS. 3A and 3B illustrate cross-sectional views of a first side assembly 210 interfacing with a roof assembly 220, it will be understood that a second side assembly 210 can interface with the roof assembly 220 in substantially the same arrangement using substantially the same components on the other side of the refrigeration trailer 200.

The roof assembly 220 can include a roof sheet 222, a roof vacuum insulated panel (VIP) 290 that includes a foam coating 292, a roof liner 224, a roof bow supporter 228, a spacer 235, and a spacer 272. In embodiments of the present disclosure, a portion or portions of the roof assembly 220 includes insulation. The roof sheet 222 and the roof liner 224 can be provided around the insulated portion of the roof assembly 220. For example, the insulated portion of the roof assembly 220 can be sandwiched between the roof sheet 222 and the roof liner 224.

In the non-limiting embodiments illustrated in FIGS. 3A and 3B, an insulated portion of the roof assembly 220 includes the roof VIP 290 that includes the foam coating 292, a spacer 235, and the spacer 272. While the examples illustrated in FIGS. 3A and 3B are described with reference to a roof VIP 290 that includes a foam coating 292, it will be understood that embodiments of the present disclosure are not limited to foam-coated VIP panels. In another example implementation, the roof insulated portion includes a roof VIP that does not include a foam coating 292. In still another example implementation, the roof insulated portion includes another form of insulation panel (with or without a foam insulation coating).

The roof insulated portion can include a combination of different types of insulation. In one non-limiting example, the roof insulated portion includes foam insulation provided around or adjacent to portions of the roof VIP. In another non-limiting example, the roof insulated portion includes foam insulation provided around or adjacent to another form of insulation panel.

The roof VIP 290 can have insulating properties. The roof VIP 290 can include a membrane wall and a porous core. The porous core can be made from a rigid, highly-porous material. The porous core can be formed from fumed silica, silica powder, fiberglass, perlite, polyurethane, aerogel, or glass wool. The membrane wall can form a thin, gas-tight outer envelope around the porous core. The porous core can be vacuum sealed within the membrane wall to form a VIP having a low thermal conductivity.

The roof VIP 290 can be coated with the foam coating 292. The foam coating 292 can protect the membrane wall of the roof VIP 290 from puncture. It can be advantageous to protect the membrane wall of the roof VIP 290 from puncture because puncturing a VIP can eliminate the vacuum seal and increase the thermal conductivity of the VIP, thereby reducing thermally insulative properties of the VIP. The foam coating 292 can encapsulate the roof VIP 290 on all sides. The roof VIP 290 can be encased in the foam coating 292. The foam coating 292 can include polyurethane (PU) foam. The PU foam can have a low thermal conductivity. In some non-limiting examples, the roof VIP 290 can have a height A. Height A can be, or be about 0.2 inches, 0.3 inches, 0.4 inches, 0.5 inches, 0.6 inches, 0.7 inches, 0.8 inches, 0.9 inches, 1 inch, 1.1 inches, 1.2 inches, 1.3 inches, 1.4 inches, 1.5 inches, 1.6 inches, 1.7 inches, 1.8 inches, 1.9 inches, 2 inches, 2.25 inches, 2.5 inches, 2.75 inches, 3 inches, or any value within a range defined by any two of the proceeding values, though in some embodiments other distances may be implemented. In one non-limiting example, height A can be 1 inch. In some non-limiting examples, the roof insulated portion including the roof VIP 290 including the foam coating 292 can have a total height of B. Height B can be, or be about 0.5 inches, 0.75 inches, 1 inch, 1.25 inches, 1.5 inches, 1.75 inches, 2 inches, 2.25 inches, 2.5 inches, 2.75 inches, 3 inches, 3.25 inches, 3.5 inches, 3.75 inches, 4 inches, 4.25 inches, 4.5 inches, 4.75 inches, 5 inches, or any value within a range defined by any two of the proceeding values, though in some embodiments other distances may be implemented. In one non-limiting example, height B can be 3 inches. In some non-limiting examples, the height B can be between 2 inches and 4 inches. A top surface of the foam coating 292 can contact the roof sheet 222. In some examples, the foam coating 292 can directly contact the roof sheet 222.

The roof liner 224 can be positioned against a bottom surface of the roof insulated portion. The roof liner 224 can be positioned against the roof VIP 290. For example, the roof liner 224 can be in direct contact with a bottom surface of the foam coating 292. The roof liner 224 can line the interior of the roof assembly 220 of the trailer 200. The roof liner 224 can protect the roof insulated portion from moisture. The roof liner 224 can protect the roof VIP 290 from moisture in the interior of the trailer 200. The roof liner 224 can protect the roof VIP 290 from impact, slicing, puncture, or other forms of structural damage. The roof liner 224 can protect the roof VIP 290 from puncture. Advantageously, the roof liner 224 can be made from a material having a relatively low thermal conductivity, thereby reducing any thermal bridging through the roof assembly 220. The roof liner 224 can be made of vinyl, composite, plastic, aluminum, or another suitable material.

The roof sheet 222 can be positioned at the top of the trailer 200. The roof sheet 222 can form an external surface of the trailer 200. The roof sheet 222 can be made of, formed from, or include aluminum, composite, plastic, or another suitable material. The roof sheet 222 can extend widthwise from the side assembly 210 to a second side assembly 210. The roof sheet 222 can extend widthwise over a plurality of roof VIPs, for example three roof VIPs. The roof sheet 222 can extend lengthwise over a plurality of roof VIPs. The roof sheet 222 can extend across a length and a width of the roof VIP 290. In some examples, the roof sheet 222 can extend a distance widthwise past a side surface 293 of the roof VIP 290. An exterior end of the roof sheet 222 can fold over and/or crimp to the top rail 260. In some non-limiting examples, the exterior end of the roof sheet 222 can be adhered to the top rail 260.

The roof bow supporter 228 can have a Z cross-sectional shape. The roof bow supporter 228 can include a first extension 232 that extends widthwise from the side surface 293 of the roof VIP 290 towards an exterior-most portion of the roof sheet 222. The roof bow supporter 228 can include a second extension 234 that extends upward from an area above the side assembly 210 to the roof sheet 222. The roof bow supporter 228 can include a third extension 236 that extends widthwise from an area adjacent to the spacer 272 to an area above the top rail 260. The roof bow supporter 228 can bend approximately 90 degrees and extend upward to form the second extension 234. The roof bow supporter 228 can bend approximately 90 degrees and extend widthwise over a portion of the top rail 260 to form the third extension 236. Advantageously, the roof bow supporter 228 can be made from a material having a relatively low thermal conductivity, thereby reducing thermal bridging at the interface between the attachment of the roof assembly 220 to the side assembly 210. The roof bow supporter 228 can be made of aluminum, composite, plastic, or another suitable material.

The spacer 272 can be positioned adjacent to the side surface 293 of the roof VIP 290. The spacer 272 can be an insulating spacer. The spacer 272 can advantageously be made of an insulative material to reduce thermal bridging through the corner assembly. The spacer 272 can be between the roof sheet 222 and the topmost surface of the side VIP 294. The spacer 272 can be positioned above the first extension 232 of the roof bow supporter 228. The spacer 272 can fill all or substantially all of a volume between the roof sheet 222, the side surface 293 of the roof VIP 290, the first extension 232 of the roof bow supporter 228, and the second extension 234 of the roof bow supporter 228. The roof assembly 220 can include a plurality of spacers 272. Each spacer 272 can extend lengthwise along the trailer 200 between two roof bows of a plurality of roof bows of the trailer 200. The spacer 272 can have a rectangular or substantially rectangular cross-section. The spacer 272 can include or be made of PU foam or another suitable insulative material.

The spacer 235 can be positioned adjacent to the side surface 293 of the roof VIP 290. The spacer 235 can be an insulating spacer. The spacer 235 can be a first insulating spacer 235 and the spacer 272 can be a second insulating spacer 272. The spacer 235 can advantageously be made of an insulative material to reduce thermal bridging through the corner assembly. The spacer 235 can be between the roof bow supporter 228 and the topmost surface of the side VIP 294. The spacer 235 can be below the first extension 232 of the roof bow supporter 228. The spacer 235 can fill all or substantially all of a volume between the side surface 293 of the roof VIP 290, the first extension 232 of the roof bow supporter 228, the topmost surface of the side VIP 294, and the top rail 260. The roof assembly 220 can include a spacer 235 which can extend lengthwise along the length of the trailer 200. The roof assembly 220 can include a plurality of spacers 235 which extend lengthwise along the length of the trailer 200. Each spacer 235 can extend lengthwise along the trailer 200 along a portion of the length of the trailer 200. In some non-limiting examples, the spacer 235 can have a rectangular or substantially rectangular cross-section. In an alternative embodiment, a different type of insulative material can be provided in lieu of the spacer 235. For example, a PU foam can sprayed to fill the voids and gaps between the side surface 293 of the roof VIP 290, the first extension 232 of the roof bow supporter 228, the topmost surface of the side VIP 294, and the top rail 260. The spacer 235 can include or be made of PU foam or another suitable insulative material. It will be understood that in embodiments of the present disclosure that include a spacer 235, a PU foam can also be sprayed in the corner assembly to fill gaps and voids, for example but not limited to gaps and voids between the side surface 293 of the roof VIP 290, the first extension 232 of the roof bow supporter 228, the topmost surface of the side VIP 294, the exterior-most side surface of the side VIP 294, and the top rail 260

The side assembly 210 can include a side sheet 212, a side VIP 294 that includes a foam coating 296, and a side liner 214. In embodiments of the present disclosure, a portion or portions of the side assembly 210 includes insulation. The side assembly 210 can be perpendicular to the roof assembly 220. The side sheet 212 and the side liner 214 can be provided around the insulated portion of the side assembly 210. For example, the insulated portion of the side assembly 210 can be sandwiched between the side sheet 212 and the side liner 214.

In the non-limiting embodiment illustrated in FIG. 3A, an insulated portion of the side assembly 210 includes the side VIP 294 that includes the foam coating 296. The side VIP 294 can be perpendicular to the roof VIP 290. The side surface 293 of the roof VIP 290 can be positioned adjacent to the side VIP 294. In some examples, the side surface 293 of the roof VIP 290 can contact the side VIP 294. In some examples, the side surface 293 can adjoin or abut the side VIP 294. While the examples illustrated in FIGS. 3A and 3B are described with reference to a side VIP 294 that includes a foam coating 296, it will be understood that embodiments of the present disclosure are not limited to foam-coated VIP panels. In another example implementation, the side insulated portion includes a side VIP that does not include a foam coating 296. In still another example implementation, the side insulated portion includes another form of insulation (with or without a foam insulation coating).

The side insulated portion can include a combination of different types of insulation. In one non-limiting example, the side insulated portion includes foam insulation provided around or adjacent to portions of the side VIP. In another non-limiting example, the side insulated portion includes foam insulation provided around or adjacent to another form of insulation panel.

The side VIP 294 can have insulating properties. The side VIP 294 can include a membrane wall and a porous core. The porous core can be made from a rigid, highly-porous material. The porous core can be formed from fumed silica, silica powder, fiberglass, perlite, polyurethane, aerogel, or glass wool. The membrane wall can form a thin, gas-tight outer envelope around the porous core. The porous core can be vacuum sealed within the membrane wall to form a VIP having a low thermal conductivity.

The side VIP 294 can be coated with the foam coating 296. The foam coating 296 can protect the membrane wall of the side VIP 294 from puncture. It can be advantageous to protect the membrane wall of the side VIP 294 from puncture because puncturing a VIP can eliminate the vacuum seal and increase the thermal conductivity of the VIP, thereby reducing thermally insulative properties of the VIP. The foam coating 296 can encapsulate the side VIP 294 on all sides. The foam coating 296 can include PU foam. The PU foam can have a low thermal conductivity. In some non-limiting examples, the side VIP 294 can have a width C. Width C can be, or be about 0.2 inches, 0.3 inches, 0.4 inches, 0.5 inches, 0.6 inches, 0.7 inches, 0.8 inches, 0.9 inches, 1 inch, 1.1 inches, 1.2 inches, 1.3 inches, 1.4 inches, 1.5 inches, 1.6 inches, 1.7 inches, 1.8 inches, 1.9 inches, 2 inches, 2.25 inches, 2.5 inches, 2.75 inches, 3 inches, or any value within a range defined by any two of the proceeding values, though in some embodiments other distances may be implemented. In one non-limiting example, width C can be 1 inch. In some non-limiting examples, the side insulated portion including the side VIP 294 including the foam coating 296 can have a total width D. Width D can be, or be about 0.5 inches, 0.75 inches, 1 inch, 1.25 inches, 1.5 inches, 1.75 inches, 2 inches, 2.25 inches, 2.5 inches, 2.75 inches, 3 inches, 3.25 inches, 3.5 inches, 3.75 inches, 4 inches, 4.25 inches, 4.5 inches, 4.75 inches, 5 inches, or any value within a range defined by any two of the proceeding values, though in some embodiments other distances may be implemented. In one non-limiting example, width D can be 3 inches. In some non-limiting examples, the width D can be between 2 inches and 4 inches. The foam coating 296 can include a foam cutout 298 configured to receive mechanical fastener components, for example components of mechanical fasteners that couple the top rail 260 to the side sheet 212.

An outward side surface of the foam coating 296 can contact the side sheet 212. In some examples, foam coating 296 can directly contact the side sheet 212. An interior side surface of the foam coating 296 can contact the side liner 214.

The side liner 214 can be positioned against the interior side surface of the side insulated portion. The side liner 214 can be positioned against the side VIP 294. For example, the side liner 214 can be in direct contact with the interior side surface of the foam coating 296. The side liner 214 can line the interior of the side assembly 210 of the trailer 200. The side liner 214 can protect the side VIP 294 from moisture in the interior of the trailer 200. The side liner 214 can protect the side VIP 294 from impact, slicing, puncture, or other forms of structural damage. Advantageously, the side liner 214 can be made from a material having a relatively low thermal conductivity, thereby reducing any thermal bridging through the side assembly 210. The side liner 214 can be made of vinyl, composite, plastic, aluminum, or another suitable material.

A top surface of the side VIP 294 can be positioned adjacent to an area below the first extension 232 of the roof bow supporter 228. In this non-limiting example, there is a gap between the roof bow supporter 228 and the top surface of the side VIP 294. In some examples, the spacer 235 is positioned within the gap between the roof bow supporter 228 and the top surface of the side VIP 294. In other examples of the present disclosure (not illustrated), the top surface of the side VIP 294 can adjoin or abut the roof bow supporter 228. For example, the foam coating 296 can adjoin or abut the roof bow supporter 228. In some non-limiting examples of the present disclosure (not illustrated), the top surface of the side VIP 294 can contact the roof bow supporter 228. For example, the top surface of the side VIP 294 can directly contact the roof bow supporter 228.

The inner corner bracket 270 can attach to the roof liner 224 and the side liner 214. The inner corner bracket 270 can advantageously form a watertight seal between the roof liner 224 and the side liner 214. The inner corner bracket 270 can be adhered to the roof liner 224 and/or to the side liner 214. The inner corner bracket 270 can be adhered to the roof liner 224 and/or to the side liner 214 using an adhesive. Other suitable methods to attach the inner corner bracket 270 to the roof liner 224 and the side liner 214 can be suitably implemented. In some non-limiting examples, the inner corner bracket 270 can include a U-shaped bracket which can slide onto the side liner 214. In some non-limiting examples, the inner corner bracket 270 can be integral to the side liner 214 or the roof liner 224.

The side sheet 212 can be positioned at the external side of the trailer 200. The side sheet 212 can form an external surface of the trailer 200. The side sheet 212 can be made of, formed from, or include aluminum, composite, plastic, or another suitable material. The side sheet 212 can extend upward and downward along the length of the side VIP 294. In some examples, a topmost end of the side sheet 212 can be positioned a distance below the top surface of the side VIP 294. In areas above the topmost end of the side sheet 212, the side VIP 294 may be in direct contact with the top rail 260.

The top rail 260 can be positioned along the external side of the side assembly 210. The top rail 260 can be positioned so that the top rail 260 overlaps an upper portion of the side sheet 212. The top rail 260 can connect to the side sheet 212 and the roof sheet 222 to form an external connection between the roof assembly 220 and the side assembly 210. A first section of an exterior side of the side VIP 294 can adjoin an inner side of the top rail 260. A second section of the exterior side of the side VIP 294 can contact the side sheet 212 of the side assembly 210.

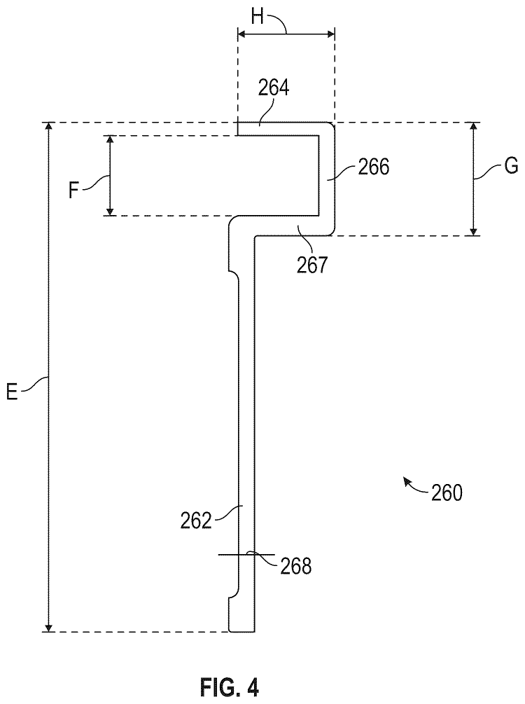

FIG. 4 illustrates a top rail 260 according to an embodiment of the present disclosure. The top rail 260 includes a roof sheet section 264, a spacer section 266, a side VIP section 267, and a side sheet section 262. The roof sheet section 264, the spacer section 266, and the side VIP section 267 can have a C-shaped cross-sectional shape. The top rail 260 can be configured to receive a fastener element 268 that couples the top rail 260 to the side sheet 212. The top rail 260 can be made of, formed from, or include aluminum, steel, stainless steel, plastic, composite, or another suitable material.

The spacer section 266 can be positioned between the roof sheet section 264 and the side VIP section 267. The roof sheet section 264 can be positioned at a top end of the spacer section 266. The spacer section 266 can space the roof sheet section 264 apart from the side VIP section 267. The spacer section 266 can extend inward from the side sheet section 262 and the roof sheet section 264. The spacer section 266 can form the inner interior-most surface of the top rail 260.

The roof sheet section 264, the spacer section 266, and the side VIP section 267 can have a C-shaped profile. The roof sheet section 264, the spacer section 266, and the side VIP section 267 can form a recessed rectangular pocket. The roof sheet section 264 can be separated from the side VIP section 267. The spacer section 266 can advantageously increase the strength and structural rigidity of the top rail 260. The roof sheet section 264 can be configured so that a fastener 280 can pass through the roof sheet 222, the roof bow supporter 228, and the roof sheet section 264. The roof sheet 222 can attach to the roof sheet section 264 of the top rail 260. In one non-limiting example, the fastener 280 can be a rivet or a bolt. The roof sheet section 264 can be configured so that one or more fasteners 280, for example, one or more rivets, can be punched through the roof sheet section 264. In another non-limiting example, the roof sheet section 264 can include one or more through holes which can receive one or more fasteners 280, which can be bolts or rivets. The spacer section 266 can be sized such that a tool for securing the one or more fasteners 280 into the roof sheet section 264 can be received in the volume below the roof sheet section 264. For example, the volume exterior to the spacer section 266 can receive a portion of a rivet gun or a wrench.

The top rail 260 can have a height E from the lower end of the side sheet section 262 to the upper surface of the roof sheet section 264. In some examples height E can be, or be about 4 inches, 4.5 inches, 5 inches, 5.5 inches, 6 inches, 6.25 inches, 6.5 inches, 6.75 inches, 7 inches, 7.5 inches, 8 inches, 8.5 inches, 9.0 inches, 9.5 inches, 10 inches, or any value within a range defined by any two of the proceeding values, though in some embodiments other distances may be implemented. In one non-limiting example, height E can be 6.3 inches.

The spacer section 266 can have an exterior dimension F measured from the upper surface of the side VIP section 267 to the lower surface of the roof sheet section 264. The roof sheet section 264 can be separated from the side VIP section 267 by the dimension F. The dimension F can define a height of a volume of the C-shaped section of the top rail 260. The dimension F can define the largest size of tool which can be received into the spacer section 266 for securing the one or more fasteners into the roof sheet section 264. In some examples dimension F can be, or be about 0.4 inches, 0.5 inches, 0.6 inches, 0.7 inches, 0.8 inches, 0.9 inches, 1.0 inches, 1.1 inches, 1.2 inches, 1.3 inches, 1.4 inches, 1.5 inches, 1.75 inches, 2.0 inches, 2.5 inches, 3.0 inches, 3.5 inches, 4.0 inches, 4.5 inches, or any value within a range defined by any two of the proceeding values, though in some embodiments other distances may be implemented. In one non-limiting example, the dimension F can be 1 inch. In one non-limiting example, the dimension F can be between 0.5 inches and 2 inches. The roof sheet section 264 can be separated from the side VIP section 267 by a distance of about 1 inch. The C-shaped section of the top rail 260 can define a volume having a height of about 1 inch. The height F can be sized to allow a tool to be received into the spacer section 266 for securing the one or more fasteners 280 into the roof sheet section 264.

The spacer section 266 can have a height G measured from the lower surface of the spacer section 266 to the upper surface of the roof sheet section 264. In some examples the height G can be, or be about 0.7 inches, 0.8 inches, 0.9 inches, 1 inch, 1.1 inches, 1.2 inches, 1.3 inches, 1.4 inches, 1.5 inches, 1.6 inches, 1.7 inches, 1.8 inches, 1.9 inches, 2.0 inches, 2.5 inches, 3 inches, 3.5 inches, 4 inches, 4.5 inches, or any value within a range defined by any two of the proceeding values, though in some embodiments other distances may be implemented. In one non-limiting example, the height G can be 1.4 inches. In one non-limiting example, the height G can be between 0.5 inches and 2 inches.

The roof sheet section 264 can have a width H measured between an interior surface and an exterior surface of the roof sheet section 264. In some examples the width H can be, or be about 0.7 inches, 0.8 inches, 0.9 inches, 1 inch, 1.1 inches, 1.2 inches, 1.3 inches, 1.4 inches, 1.5 inches, 1.6 inches, 1.7 inches, 1.8 inches, 1.9 inches, 2.0 inches, 2.5 inches, 3 inches, 3.5 inches, 4 inches, 4.5 inches, or any value within a range defined by any two of the proceeding values, though in some embodiments other distances may be implemented. In one non-limiting example, the width H can be 1.4 inches.

The width H can advantageously be minimized to reduce thermal bridging and thereby increase the thermal efficiency of the trailer 200. The height G can advantageously be minimized to reduce thermal bridging and thereby increase the thermal efficiency of the trailer 200. The height G can be minimized, while also maintaining the dimension F, such that a tool for securing the one or more fasteners into the roof sheet section 264 can be received into the volume adjacent to the spacer section 266.

As illustrated in FIGS. 3A and 3B, the height G of the spacer section 266 can advantageously be reduced to a dimension that results in the roof insulation portion extending below the bottom of the spacer section 266 (thereby reducing thermal bridging in embodiments of the present disclosure), while still maintaining a dimension that allows a fastener 280 to be installed to couple the roof sheet 222, the roof bow supporter 228, and the top rail 260. The height G of the spacer section 266 can also advantageously be reduced to a dimension that results in the roof VIP 290 overlapping with the side insulation portion along a substantial section of the side surface 293 of the roof VIP 290 (for example, about 50% or more of the side surface 293 of the roof VIP 290). In some examples, the height G can be greater than the height of the second extension 234 of the roof bow supporter 228. The height G of the spacer section 266 can be greater than the height of the spacer 272. In some non-limiting examples (not illustrated), the height G of the spacer section 266 can be substantially the same as the height of the second extension 234 of the roof bow supporter 228. In some non-limiting examples (not illustrated), the spacer 272 can be substantially the same height as the height G of the spacer section 266. The roof bow supporter 228 can be between the top rail 260 and the roof VIP 290. The spacer 272 can be above the roof bow supporter 228. The spacer 235 can be below the roof bow supporter 228.

The spacer 272 can adjoin or abut the side surface of the foam coating 292 of the roof VIP 290. In some examples, the spacer 272 can contact the side surface 293 of the roof VIP 290. A top surface of the spacer 272 can be positioned to be substantially parallel with the top surface of the foam coating 296 of the side VIP 294. The spacer 272 can be positioned to fill a volume between the foam coating 292, the foam coating 296, the top rail 260, and the roof sheet 222. The spacer 272 can be sized and shaped to fill a volume between the foam coating 292 of the roof VIP 290, the foam coating 296 of the side VIP 294, the top rail 260, and the roof sheet 222.

The spacer 235 can adjoin or abut the side surface of the foam coating 292 of the roof VIP 290. In some examples, the spacer 235 can contact the side surface 293 of the roof VIP 290. A bottom surface of the spacer 235 can adjoin or abut the top surface of the foam coating 296 of the side VIP 294. A bottom surface of the spacer 235 can contact the top surface of the foam coating 296 of the side VIP 294. The spacer 235 can be positioned to fill a volume between the foam coating 292, the foam coating 296, the top rail 260, and the roof bow supporter 228.

The side sheet section 262 can overlap an upper portion of the side sheet 212. The fastener element 268 can be positioned near the lower end of the side sheet section 262. The fastener element 268 can be positioned in the portion of the side sheet section 262 that overlaps with the side sheet 212. The top rail 260 can be attached to the side sheet 212 at the fastener element 268. In some non-limiting examples, the fastener element 268 can be a fastener which attaches the top rail 260 to the side sheet 212. In some non-limiting examples, the fastener element 268 can be a rivet or a threaded boss. In some examples, the foam coating 296 can include a foam cutout 298 which can provide clearance for a fastener passing through the fastener element 268. The roof sheet section 264 can be substantially perpendicular to the side sheet section 262.

The spacer section 266 of the top rail 260 can be positioned above the foam coating 296 of the side VIP 294. A top surface of the foam coating 296 can be positioned adjacent to the side VIP section 267 of the top rail 260. The top surface of the foam coating 296 can adjoin the top rail 260. In some non-limiting examples, the bottom surface of the side VIP section 267 can contact the foam coating 296. In some non-limiting examples, the bottom surface of the side VIP section 267 can directly contact the top surface of the foam coating 296. The exterior side of the foam coating 296 can contact the inner side of the side sheet section 262 of the top rail 260. A side surface 293 of the foam coating 292 of the roof VIP 290 can be positioned adjacent to the inner side surface of the foam coating 296 of the side VIP 294. The foam coating 292 of the roof VIP 290 can adjoin or abut the foam coating of the side VIP 294. In some example implementations, the side surface of the foam coating 292 of the roof VIP 290 can directly contact the inner side surface of the foam coating 296 of the side VIP 294.

At least a portion of the side VIP 294 can be inward of the interior-most surface of the top rail 260. The roof VIP 290 can be inward of the interior-most surface of the top rail 260. In some non-limiting examples, the roof VIP 290 can be positioned inward of the spacer section 266. The lowermost surface of the roof VIP 290 can be below the topmost surface of the side VIP 294. The lowermost surface of the roof VIP 290 can be positioned at least partially below the side VIP section 267 of the top rail 260. The side VIP 294 can be positioned at least partially inward from the interior-most surface of the spacer section 266. The spacer 272 can be between the top rail 260 and the roof VIP 290. The spacer 272 can adjoin or abut the side surface 293 of the foam coating of the roof VIP 290. The spacer 272 can be above a top surface of the foam coating 296 of the side VIP 294. The spacer 235 can be between the top rail 260 and the roof VIP 290. The spacer 235 can adjoin or abut the top surface of the foam coating of the side VIP 294. The spacer 235 can be between the roof bow supporter 228 and the side VIP 294.

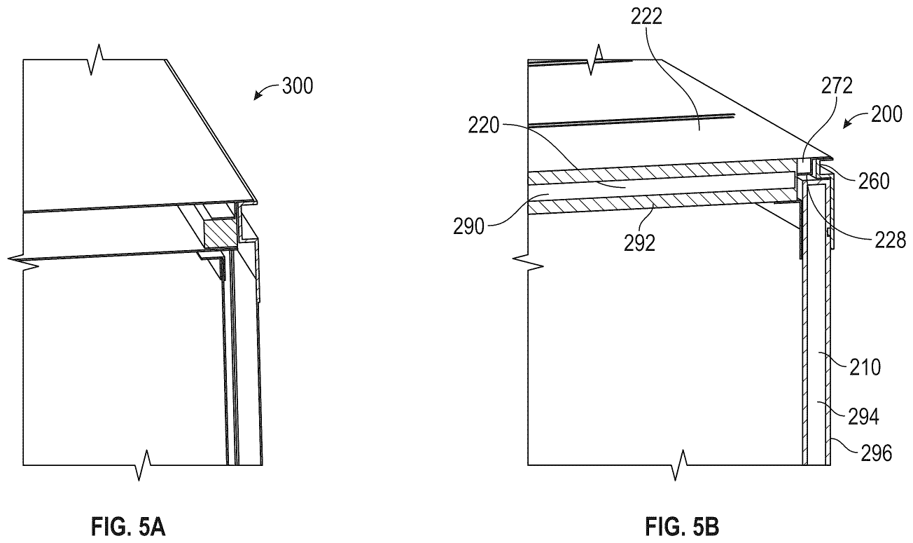

FIG. 5A illustrates a perspective section view of a corner assembly of a traditional trailer 300 using PU foam insulation. FIG. 5B illustrates a perspective section view of a corner assembly of a trailer 200 according to an embodiment of the present disclosure. Advantageously, the trailer 200 includes the same or substantially the same wall thickness as the trailer 300 while improving thermal efficiency. The spacer 272, spacer 235, the roof bow supporter 228, and the top rail 260 of the trailer 200 are advantageously sized and shaped to position the roof insulating portion and the side insulating portion relative to each other such that thermal bridging is significantly reduced compared to the trailer 300. The spacer 272 can be positioned above the roof bow supporter 228 in the trailer 200 rather than below the roof bow supporter as in the trailer 300. The position of the spacer 272 above the roof bow supporter 228 in the trailer 200 can advantageously reduce thermal bridging by removing and/or reducing the size of open voids or volumes in the corner assembly of the trailer 200. The spacer 235 can be positioned below the roof bow supporter 228 in the trailer 200 to advantageously fill a gap or void between the roof bow supporter 228, the top rail 260, the roof VIP 290, and the side VIP 294. The position of the spacer 235 below the roof bow supporter 228 in the trailer 200 can advantageously reduce thermal bridging by removing and/or reducing the size of open voids or volumes in the corner assembly of the trailer 200. Advantageously, the trailer 200 can accommodate industry standard techniques to connect the roof sheet 222 to the top rail 260. Thus, the improved insulating properties of the trailer 200 can be achieved while maintaining the waterproof connection between the roof sheet 222 and the top rail 260.

Advantageously, the positioning of the roof VIP 290 and the side VIP 294 relative to each other can reduce any thermal bridging from the top rail 260 into the interior of the trailer 200. The roof insulated portion, which can include the roof VIP 290 including the foam coating 292 and the spacer 272, and the side insulated portion, which can include the side VIP 294 including the foam coating 296, can be positioned such that any thermal vector from the exterior of the trailer 200 to the interior of the trailer 200 (or alternatively, from the interior to the exterior) passes through at least one of the roof insulated portion and the side insulated portion. Any horizontal cross-section taken along a height of the top rail 260 can pass through at least one of the roof VIP 290 and the side VIP 294. Advantageously, the positioning of the roof VIP 290 and the side VIP 294 can ensure that there is no uninsulated portion of the top rail 260 that is exposed to the interior of the trailer 200. The roof VIP 290 inward of an interior-most surface of a top rail 260 and at least a portion of the side assembly inward of an interior-most surface of the top rail 260 can advantageously reduce any thermal bridging from the top rail 260 to the interior of the trailer 200. The heat transmission rate of a trailer 200 including a corner assembly as described herein can be, be about, or be less than 100 BTU/HF, 105 BTU/HF, 107 BTU/HF, or 110 BTU/HF or any value within a range defined by any two of the proceeding values. In some non-limiting examples, the heat transmission rate of the corner assembly as described herein can be 107 BTU/HF. The heat transmission rate of the trailer 200 including insulated corner assemblies according to embodiments of the present disclosure can reduce the heat transmission rate of the trailer 200 when compared to a trailer which does not use VIPs. In some examples, the reduction in heat transmission rate can be, be about, or be more than about 40 BUT/HF, 43 BTU/HF, 45 BTU/HF, or 50 BTU/HF or any value within a range defined by any two of the proceeding values. In addition, trailers including insulated corner assemblies according to embodiments of the present disclosure can significantly reduce thermal bridging and heat transmission relative to thermal bridging and heat transmission in a refrigeration trailer such as that illustrated in FIG. 1, which includes VIP insulation and a conventional insulated corner assembly (having, for example, a conventional top rail). Further, as described above, embodiments of the present disclosure are described with reference to insulated upper corner assemblies in refrigeration trailers, such as trailer 100 and trailer 200, it will be understood that insulated upper corner assemblies according to the present disclosure can be suitably implemented on many different platforms, including but not limited to van trucks and truck bodies, storage containers, and refrigerated spaces in buildings, watercraft, and other types of vehicles.

The above-described embodiments have been provided by way of example, and the present invention is not limited to these examples. Multiple variations and modifications to the disclosed embodiments will occur, to the extent not mutually exclusive, to those skilled in the art upon consideration of the foregoing description. Additionally, other combinations, omissions, substitutions and modifications will be apparent to the skilled artisan in view of the disclosure herein. Accordingly, the present disclosure is not intended to be limited by the disclosed embodiments.

Any feature or combination of features described herein are included within the scope of the present disclosure provided that the features included in any such combination are not mutually inconsistent as will be apparent from the context, this description, and the knowledge of one skilled in the art. In addition, any feature or combination of features may be specifically excluded from any embodiment of the present disclosure. For purposes of summarizing the present disclosure, certain aspects, advantages, and novel features of the present disclosure are described herein. Of course, not necessarily all such aspects, advantages, or features will be present in any particular embodiment of the present disclosure.

Embodiments presented herein are by way of example and not by way of limitation. The intent of the following detailed description, although discussing exemplary embodiments, is to be construed to cover all modifications, alternatives, and equivalents of the embodiments as may fall within the spirit and scope of the disclosure.

What is claimed is:

1. An insulated corner assembly for a trailer or truck, the assembly comprising:
a top rail configured to couple a roof assembly to a side assembly, the roof assembly comprising a roof vacuum insulated panel (VIP) inward of an interior-most surface of the top rail, the side assembly comprising a side VIP perpendicular to the roof VIP, at least a portion of the side VIP inward of the interior-most surface of the top rail; and
an insulating spacer between the top rail and the roof VIP.

2. The insulated corner assembly of claim 1, wherein a top surface of a foam coating of the side VIP adjoins the top rail.

3. The insulated corner assembly of claim 2, wherein a foam coating of the roof VIP adjoins the foam coating of the side VIP.

4. The insulated corner assembly of claim 3, wherein the insulating spacer adjoins a side surface of the foam coating of the roof VIP, and wherein the insulating spacer is above the top surface of the foam coating of the side VIP.

5. The insulated corner assembly of claim 1, further comprising a roof bow supporter between the top rail and the roof VIP, wherein the insulating spacer is above the roof bow supporter.

6. The insulated corner assembly of claim 1, further comprising a roof bow supporter between the top rail and the roof VIP, wherein the insulating spacer is below the roof bow supporter.

7. The insulated corner assembly of claim 1, wherein any horizontal cross-section taken along a height of the top rail passes through at least one of the roof VIP and the side VIP.

8. The insulated corner assembly of claim 1, wherein a lowermost surface of the roof VIP is below a topmost surface of the side VIP.

9. The insulated corner assembly of claim 1, wherein a first section of an exterior side of the side VIP adjoins an inner side of the top rail, and a second section of the exterior side of the side VIP contacts a side sheet of the side assembly.

10. The insulated corner assembly of claim 1, wherein the top rail includes a roof sheet section separated from a side VIP section of the top rail by a distance of about 1 inch.

11. An insulated corner assembly for a trailer or truck, the assembly comprising:
a roof assembly comprising a roof insulated portion comprising a roof vacuum insulated panel (VIP) encased in a foam coating;
a side assembly comprising a side insulated portion comprising a side VIP encased in a foam coating, a lowermost surface of the roof VIP below a topmost surface of the side VIP; and
a top rail configured to attach the roof assembly to the side assembly.

12. The insulated corner assembly of claim 11, wherein any horizontal cross-section taken through the top rail passes through at least one of the roof VIP and the side VIP.

13. The insulated corner assembly of claim 11, wherein the top rail comprises a spacer section having a height between 0.5 inches and 2 inches and a width between 0.5 inches and 2 inches.

14. The insulated corner assembly of claim 11, wherein the roof insulated portion has a height between 2 inches and 4 inches, and wherein the side insulated portion has a width between 2 inches and 4 inches.

15. The insulated corner assembly of claim 11, further comprising a roof sheet attached to a roof sheet section of the top rail.

16. The insulated corner assembly of claim 15, further comprising a first insulating spacer between the roof sheet and the topmost surface of the side VIP.

17. The insulated corner assembly of claim 16, wherein the roof assembly further comprises a roof bow supporter between the top rail and the roof VIP, and wherein the first insulating spacer is below the roof bow supporter.

18. The insulated corner assembly of claim 17, further comprising a second insulating spacer above the roof bow supporter.

19. The insulated corner assembly of claim 11, wherein the roof VIP is inward of an interior-most surface of the top rail, and at least a portion of the side VIP is inward of the interior-most surface of the top rail.

20. The insulated corner assembly of claim 11, wherein the top rail includes a C-shaped section that defines a volume having a height of about 1 inch.
